(19) United States
(12) Patent Application Publication
(10) Pub. No.: US 2026/0192387 A1
(43) Pub. Date: Jul. 9, 2026

(54) ULTRA-FAST LASER SCANNING ASSISTED INTEGRATED WELDING METHOD FOR MICRO CASTING AND FORGING

(71) Applicant: HARBIN WELDING INSTITUTE LIMITED COMPANY, Harbin, Heilongjiang (CN)

(72) Inventors: Yicheng YANG, Harbin, Heilongjiang (CN); Bing DU, Harbin, Heilongjiang (CN); Fujia XU, Harbin, Heilongjiang (CN); Zhen LEI, Harbin, Heilongjiang (CN); Ruisheng HUANG, Harbin, Heilongjiang (CN); Dakui FEI, Harbin, Heilongjiang (CN); Yandong ZHANG, Harbin, Heilongjiang (CN); Rong LI, Harbin, Heilongjiang (CN); Xiaomei LIANG, Harbin, Heilongjiang (CN); Jipeng ZOU, Harbin, Heilongjiang (CN); Hao CAO, Harbin, Heilongjiang (CN); Bao JIANG, Harbin, Heilongjiang (CN); Xin NIE, Harbin, Heilongjiang (CN); Pengbo HAN, Harbin, Heilongjiang (CN); Hongwei LI, Harbin, Heilongjiang (CN)

(21) Appl. No.: 18/832,091

(22) PCT Filed: Nov. 10, 2022
(86) PCT No.: PCT/CN2022/131152

§ 371 Date: Jul. 22, 2024

(30) Foreign Application Priority Data
Oct. 28, 2022 (CN) 202211331013.8

(51) Int. Cl. B23K 26/211; B23K 26/082; B23K 26/24

(52) U.S. Cl. CPC B23K 26/211; B23K 26/082; B23K 26/24

(57) ABSTRACT

Disclosed is an ultra-fast laser scanning assisted integrated welding method for micro casting and forging, including the following steps: Step one, preparing liquid metal in a melt crucible; Step two: setting a heating temperature of a guide tube; Step three: calculating an amount of the liquid metal to be filled per unit time; Step four: setting a distance between a micro casting and forging area and a liquid metal outflow area; Step five: designing a wobbling mode of ultra-fast laser scanning, with a wobbling amplitude, a wobbling frequency and a laser power, and meanwhile setting a shielding gas flow rate; Step six: checking whether devices are in good working conditions or not; Step seven: setting start-stop signals of a crucible system, an ultrafast laser auxiliary system, and a micro-forging system when a welding trajectory changes, respectively; and Step eight: turning on the device to start welding.

### CROSS-REFERENCE TO RELATED APPLICATION

This patent application is a U.S. national stage application of International Patent Application No. PCT/CN2022/131152, filed Nov. 10, 2022, which claims the benefit of and priority to Chinese Patent Application No. 202211331013.8, filed Oct. 28, 2022, each of which is hereby incorporated by references herein in its entirety.

### TECHNICAL FIELD

The present disclosure relates to the technical field of material processing engineering, in particular to an ultra-fast laser scanning assisted integrated welding method for micro casting and forging.

### BACKGROUND

For fusion welding technology, a series of energy conversions are required to convert energy forms such as electric energy or light energy into heat for melting materials, the materials melt to form a liquid molten pool, which solidifies to form a weld seam to connect the materials together, thus achieving the binding at molecular or atomic scale. The controllability of the energy mentioned above has a direct impact on the stability of the welding process as well as the welding quality, and is even a prerequisite for directly determining whether the process can be applied in engineering. The main reason why the energy forms of electric energy represented by arcs and light energy represented by lasers have a significant influence on the welding process is that in order to locally melt the workpiece to be welded, the energy density or total energy value used should be high enough. The problems caused by high energy density or total energy value are significant changes in the physical properties of materials, the controllability of the process is reduced, resulting in technical problems such as splashing and energy discontinuity for effectively melting the workpiece. These problems are the key factors that prevent the quality of the workpiece produced by welding, a hot processing technology, from being accurately guaranteed.

### SUMMARY

An objective of the present disclosure is to provide an ultra-fast laser scanning assisted integrated welding method for micro casting and forging, so as to solve the problems in the prior art. The method ensures that a substrate and delivered liquid metal are effectively fused together, thus achieving efficient and high-quality welding.

To achieve the objective above, the present disclosure provides the following technical solution.

The present disclosure provides an ultra-fast laser scanning assisted integrated welding method for micro casting and forging, including the following steps:
Step one: according to material characteristics of a structure to be welded, preparing liquid metal alloy in a melt crucible;
Step two: according to physical characteristics of a material, setting a heating temperature of a guide tube;
Step three: based on a welding speed v, a designed thickness h of a single layer per unit time, and a width w1 of a lower edge and a width w2 of an upper edge of a groove at different positions that vary with a welding height, calculating an amount Q0 of liquid metal to be filled per unit time according to formula (1);

$$Q 0 = 0.5 * h * ( w 1 + w 2 ) * v \qquad ( 1 )$$

Step four: setting a distance d between a micro-forging area and a liquid metal outflow area;
Step five: based on shape of a groove in an area to be welded, designing a wobbling mode of an ultra-fast laser scanning with a wobbling amplitude a, a wobbling frequency f, and a laser power P, and meanwhile setting a shielding gas flow rate Q1, the laser is not limited to infrared laser with a long wavelength, but can also be green light with a short wavelength, as long as the laser can be used for heating.
Step six: checking whether the melt crucible, the guide tube, the shielding gas, a laser for emitting ultra-fast laser, and a forging device are in good working conditions or not;
Step seven: according to the process flow, setting start-stop signals of a crucible system for controlling a working state of the melt crucible, an ultrafast laser auxiliary system for controlling a working state of the laser device, and a micro-forging system for controlling a state of the forging device when a welding trajectory changes, respectively, the control and structural form of each system are all known in the prior art, and thus are not described in detail; the start and stop signals of the crucible system are at a same position as those of the ultrafast laser auxiliary system, and the time is recorded as T; the time of the start and stop signals of the micro-forging system can be calculated by dividing the distance d between the micro-forging area and the high temperature liquid metal outflow area by the welding speed v, and the time can be postponed; and
Step eight: turning on the device to start welding.

According to the present disclosure, under the irradiation of the ultra-fast laser scanning, a laser irradiation area includes a front edge surface substrate material of the area to be welded and a front edge area of the liquid metal. The wobbling laser irradiation area including the front edge surface substrate material of the area to be welded refers to a range of 0-10 mm from the front edge of the molten high-temperature liquid metal flowing out of the guide tube. The wobbling laser irradiation area including the front edge area of the liquid metal refers to a partial area of a flowing front edge of the molten high-temperature liquid metal flowing out of the guide tube, with a width of 0-2 mm. Integrated micro casting and forging refers to the integration of the micro casting and the micro forging. The micro casting process and micro forging process are relative to the traditional casting and forging of large-scale structures. The micro casting refers to the process in which the molten high-temperature metal liquid flows out of the guide tube and enters the area to be welded to fill the weld seam, while the micro forging refers to the process in which local areas with good plastic toughness in the high-temperature area are post-treated by means of auxiliary means such as ultrasound. The implementation process of this method includes sending the molten high-temperature liquid melt to the area to be welded through the guide tube whose flow rate and heat can be effectively controlled, moving the guide tube, and enabling the liquid metal at a rear end to solidify to form the weld seam. The controllable flow rate means that the volume of metal flowing out of the guide tube per unit time can be accurately controlled, and the flow rate error is controlled within +/−10 mL/min. The controllable heat means that the temperature of a wall of the guide tube can be detected in real time, and the temperature of the molten high-temperature liquid metal in the guide tube can be regulated in real time, and the error range of temperature feedback control is controlled within ±2° C., to ensure that the temperature of the outflow liquid metal is consistent and controllable. Meanwhile, in order to improve the compactness of the solidified weld seam and refine the grain size of the weld seam, the micro forging method is used to impact the weld seam to improve the comprehensive mechanical properties of the weld seam. In addition, in order to prevent the problem of the molten liquid metal flowing out of the guide tube is insufficient to melt the substrate, resulting in lack of fusion of the root, sidewall or interlayer, a specially designed ultra-fast scanning laser is used to irradiate, heat, and melt both the front edge surface substrate material of the area to be welded and the front edge area of the flowing liquid metal, so as to ensure that the substrate and the delivered liquid metal can be effectively fused together, achieving efficient and high-quality welding.

Optionally, the wobbling frequency of the ultra-fast laser scanning is from 0.5 kHZ to 2.0 kHZ.

Optionally, a wobbling trajectory formed by the wobbling mode of the ultrafast laser scanning is a circular, 8-shaped or any closed-loop trajectory. The wobbling mode in which the laser wobbling trajectory is a closed-loop trajectory refers to a composite trajectory formed by the superposition of the welding speed and a laser wobbling speed vector during the welding process, and there are two intersecting points on the composite trajectory.

Optionally, in Step two, the heating temperature of the guide tube is 10-20° C. higher than a melting point of the prepared liquid metal alloy.

Optionally, in Step four, the distance between the micro-forging area and the liquid metal outflow area is from 20 mm to 60 mm.

Compared with the prior art, the present disclosure achieves the following technical effects:

Compared with the method of filling a weld seam by liquid metal formed by melting a welding wire under the action of a heat source, there is no need for the welding wire in this method, which reduces the manufacturing cost of the welding wire, and also reduces the technical problem of unstable welding process caused by poor stability of wire feeding process. Compared with the liquid metal formed by melting the traditional welding wire, the composition of the molten liquid metal in this process method can be adjusted at will. In addition, the integrated processing and preparation of a gradient material/gradient performance of the weld seam can be achieved by adjusting alloy composition of the molten liquid metal. In this process method, there is no need to melt the material by means of a heat source with high energy density, and thus the key problems of uncontrollable liquid metal flow, large splashing, easy formation of internal pores, and large weld fumes in the traditional welding process are solved, so that the surface forming quality of the weld seam and the welding environment are greatly improved. The weld seam formed after the solidification of the molten liquid metal belongs to a non-equilibrium casting process. After forging by an auxiliary method, the structure is refined and its performance is close to that of the forging, which can also significantly reduce the stress level of a welded component and improve the overall performance of the welded component. The front edge of the area to be welded and the front edge area of the flowing liquid metal are irradiated, heated, and melted by the scanning laser, which ensures that the liquid metal flowing out of the guide tube is fully fused with the substrate melting material to prevent the problem of lack of fusion of the interlayer or side wall, and the high-temperature area irradiated by the laser is also beneficial to the flow of the liquid metal and the formation of the weld seam. The ultra-fast laser is only applied on the surface of the substrate, and the temperature of the liquid metal flowing out of the guide tube is slightly higher than the melting point of the metal, so the damage to the substrate during the formation process of the weld seam is small, which is extremely beneficial to improve the mechanical properties of a welded joint. The advantage of using the ultra-fast laser scanning is that the action time of the laser on a certain micro area can be reduced, the action frequency of the laser per unit time is increased, thus ensuring as much as possible that different areas are in a molten state with a shallow penetration.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still obtain other drawings from these accompanying drawings without creative efforts.

FIG. 1 is a schematic diagram of a working state of an ultra-fast laser scanning assisted integrated welding for micro casting and forging according to the present disclosure.

In the drawings: 1 melt crucible; 2 ultra-fast laser; 3 guide tube; 4 flow switch; 5 weld seam; 6 substrate; 7 molten pool; 8 laser scanning area; 9 high-frequency micro forging device.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide an ultra-fast laser scanning assisted integrated welding method for micro casting and forging, so as to solve the problems in the prior art, and ensure that a substrate and delivered liquid metal are effectively fused together, achieving efficient and high-quality welding.

In order to make the objective, technical solutions and advantages of the present disclosure more clearly, the present disclosure is further described in detail below with reference to the embodiments.

The present disclosure provides an ultra-fast laser scanning assisted integrated welding method for micro casting and forging, including the following steps:
Step one: according to material characteristics of a structure to be welded, liquid metal alloy is prepared in a melt crucible;
Step two: according to physical characteristics of a material, a heating temperature of a guide tube is set;
Step three: based on a welding speed v, a designed thickness h of a single layer per unit time, and a width w1 of a lower edge and a width w2 of an upper edge of a groove at different positions that vary with a welding height, an amount Q0 of liquid metal to be filled per unit time is calculated according to formula (1);

$$Q 0 = 0.5 * h * ( w 1 + w 2 ) * v \qquad ( 1 )$$

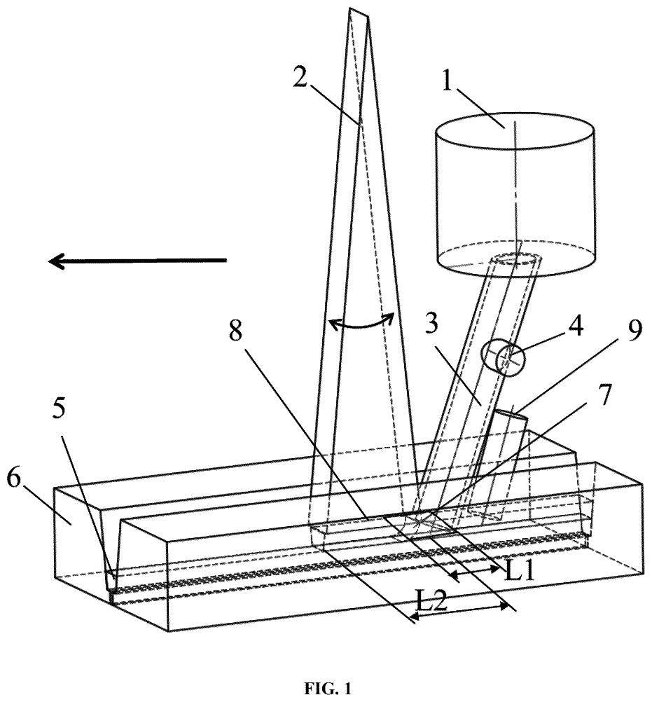

Step four: a distance d between a micro-forging area and a liquid metal outflow area is set;
Step five: based on shape of a groove in an area to be welded, a wobbling mode of an ultra-fast laser scanning with a wobbling amplitude a, a wobbling frequency f, and a laser power P is designed, and meanwhile a shielding gas flow rate Q1 is set, the laser is not limited to infrared laser with a long wavelength, but can also be green light with a short wavelength, as long as the laser can be used for heating;
Step six: whether the melt crucible, the guide tube, the shielding gas, the laser, and a forging device are in good working conditions or not is checked;
Step seven: according to the process flow, start-stop signals of a crucible system, an ultrafast laser auxiliary system, and a micro-forging system when a welding trajectory changes are set, respectively, the start and stop signals of the crucible system are at a same position as those of the ultrafast laser auxiliary system, and the time is recorded as T; the time of the start and stop signals of the micro-forging system can be calculated by dividing the distance d between the micro-forging area and the high temperature liquid metal outflow area by the welding speed v, and the time can be postponed;
Step eight: the device is turned on to start welding. As shown in FIG. 1, an arrow direction in FIGURE is a welding direction. Under the irradiation of the scanning of the ultra-fast laser 2, a laser irradiation area, i.e., a laser scanning area 8, includes a front edge surface substrate material of an area to be welded, and a front edge area of liquid metal, and a length of the laser scanning area 8 is L2. The wobbling laser irradiation area including the front edge surface substrate material of the area to be welded refers to a range of 0-10 mm from the front edge of the molten high-temperature liquid metal flowing out of the guide tube. The wobbling laser irradiation area including the front edge area of the liquid metal refers to a partial area of a flowing front edge of the molten high-temperature liquid metal flowing out of the guide tube, with a width of 0-2 mm. Integrated micro casting and forging refers to the integration of the micro casting and the micro forging. The micro casting process and micro forging process are relative to the traditional casting and forging of large-scale structures. The micro-casting refers to the process in which the molten high-temperature metal liquid in the metal crucible 1 flows out of the guide tube 3 and enters the area to be welded to form a liquid molten pool 7 with a length of L1, which is used for filling the weld seam, while the micro forging refers to the process in which local areas with good plastic toughness in the high-temperature area are post-treated by means of auxiliary means such as ultrasound. The implementation process of this method includes sending the molten high-temperature liquid melt to the area to be welded through the guide tube 3 whose flow rate and heat can be effectively controlled, moving the guide tube 3, and enabling the liquid metal at a rear end to solidify to form the weld seam. The controllable flow rate means that a flow switch 4 is arranged on the guide tube 3, and the volume of the outflow metal per unit time can be accurately controlled, and the flow rate error is controlled within +/−10 mL/min. The controllable heat means that the temperature of a wall of the guide tube 3 can be detected in real time, and the temperature of the molten high-temperature liquid metal in the guide tube can be regulated in real time, and the error range of temperature feedback control is controlled within ±2° C., to ensure that the temperature of the outflow liquid metal is consistent and controllable. Meanwhile, in order to improve the compactness of the solidified weld seam 5 and refine the grain size of the weld seam, a high-frequency micro forging device 9 is used to impact the weld seam by the micro forging method, so as to improve the comprehensive mechanical properties of the weld seam 5. In addition, in order to prevent the problem of the molten liquid metal flowing out of the guide tube 3 is insufficient to melt the substrate, resulting in lack of fusion of the root, sidewall or interlayer, a specially designed ultra-fast scanning laser is used to irradiate, heat, and melt both the front edge surface substrate material of the area to be welded and the front edge area of the flowing liquid metal, so as to ensure that the substrate 6 and the delivered liquid metal can be effectively fused together, achieving efficient and high-quality welding.

### Embodiment 1

Based on the technical key points of this method, a Q960E steel butt weld seam with a thickness of 60 mm for construction machinery is used as an example for illustration, a length L of a test plate is 1000 mm, a groove is in a form of double U-shaped groove, a radius R of a bottom transition angle is 4 mm, and a groove angle is 8 degrees.
Step one, according to material characteristics of a structure to be welded, molten metal with the same material as Q960E steel is molten in a melt crucible;
Step two, according to physical characteristics of a material, a heating temperature of a guide tube is set, wherein the heating temperature of the guide tube is 10-20° C. higher than a melting point of the Q960E steel;
Step three, a welding speed v is 0.6 m/min, i.e., 10 mm/s, an increase in a height h of the single-layer molten metal is designed to be 5+/−1 mm, and a width w1 of a lower edge and a width w2 of an upper edge of the groove at different positions vary with a welding height, an amount Q0 of metal to be filled per unit time is calculated according to formula (1):

$$Q 0 = 0.5 * 5 * ( w 1 + w 2 ) * 10 \qquad ( 1 )$$

Step four, a distance d between a micro-forging area and a liquid metal outflow area is set to be 30 mm;
Step five, based on shape of a groove in an area to be welded, a laser wobbling mode is designed, wherein a wobbling amplitude a is initially set to be 10 mm, and increases by 2 mm each time with the count backwards, a wobbling frequency f is set to be 1 Khz, a laser power P is set to be 3 kW, and a shielding gas flow rate Q1 is set to be 50 L/min;
Step six, whether the melt crucible, the guide tube, the shielding gas, the laser, and a forging device are in good working conditions or not is checked;
Step seven, according to the process flow, start-stop signals of a crucible system, an ultrafast laser auxiliary system and a micro-forging system when a welding trajectory changes are set, respectively, the start and stop signals of the crucible system are at a same position as those of the ultrafast laser auxiliary system, and the time is recorded as T; the time of the start and stop signals of the micro-forging system can be calculated by dividing the distance d between the micro-forging area and the high temperature liquid metal outflow area by the welding speed v, and the time can be postponed by 3s;
Step eight, the device is turned on to start welding.

Compared with the traditional arc welding or laser-arc hybrid welding method, in the present welding method, there is no process with intense fluctuations of the heat source, the welding process is extremely stable, and the defect rates such as porosity, inclusions, lack of fusion of the interlayer and sidewall are well inhibited, and the defect-free connection of the weld seam can be achieved. Through proper hammering process, the stress of the weld seam is well released, the number of dislocations in the weld seam is increased, and both the deformation and mechanical properties after welding are greatly improved. Compared with the arc welded structures, the mechanical property of the weld seam is improved by 6%, and the deformation after welding is reduced by 60%.

In the description of the present disclosure, it needs to be understood that the orientation or positional relationship indicated by terms “center”, “top”, “bottom”, “left”, “right”, “vertical”, “horizontal”, “inside” and “outside” is based on the orientation or positional relationship shown in the drawings only for convenience of description of the present disclosure and simplification of description rather than indicating or implying that the apparatus or element referred to must have a particular orientation, be constructed and operate in a particular orientation, and thus are not to be construed as limiting the present disclosure. Furthermore, the terms “first” and “second” are used for descriptive purposes only and are not to be construed as indicating or implying relative importance.

Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

1. An ultra-fast laser scanning assisted integrated welding method for micro casting and forging, comprising the following steps:
Step one: according to material characteristics of a structure to be welded, preparing liquid metal in a melt crucible;
Step two: according to physical characteristics of a material, setting a heating temperature of a guide tube;
Step three: based on a welding speed, a designed thickness of a single layer per unit time, and a width of lower edge and a width of an upper edge of a groove at different positions that vary with a welding height, calculating an amount of the liquid metal to be filled per unit time;
Step four: setting a distance between a micro-forging area and a liquid metal outflow area;
Step five: based on shape of a groove in an area to be welded, designing a wobbling mode of an ultra-fast laser scanning with a wobbling amplitude, a wobbling frequency, and a laser power, and meanwhile setting a shielding gas flow rate;
Step six: checking whether the melt crucible, the guide tube, the shielding gas, a laser for emitting ultra-fast laser, and a forging device are in good working conditions or not;
Step seven: according to the process flow, setting start-stop signals of a crucible system, an ultrafast laser auxiliary system, and a micro-forging system when a welding trajectory changes, respectively, the start and stop signals of the crucible system are at a same position as those of the ultrafast laser auxiliary system; and
Step eight: turning on the device to start welding.

2. The ultra-fast laser scanning assisted integrated welding method for micro casting and forging according to claim 1, wherein the wobbling frequency of the ultra-fast laser scanning is from 0.5 kHZ to 2.0 kHZ.

3. The ultra-fast laser scanning assisted integrated welding method for micro casting and forging according to claim 1, wherein the wobbling mode of the ultrafast laser scanning is a circular, “8”-shaped or any closed-loop trajectory.

4. The ultra-fast laser scanning assisted integrated welding method for micro casting and forging according to claim 1, wherein in Step two, the heating temperature of the guide tube is 10-20° C. higher than a melting point of the prepared liquid metal.

5. The ultra-fast laser scanning assisted integrated welding method for micro casting and forging according to claim 1, wherein in Step four, the distance between the micro-forging area and the liquid metal outflow area is 20-60 mm.
